(19) United States
(12) Patent Application Publication
(10) Pub. No.: US 2018/0284559 A1
(43) Pub. Date: Oct. 4, 2018

(54) ELECTRO-OPTIC MODULATOR

(71) Applicants: NEC CORPORATION, Tokyo (JP); PHOTONICS ELECTRONICS TECHNOLOGY RESEARCH ASSOCIATION, Tokyo (JP)

(72) Inventors: Junichi FUJIKATA, Tokyo (JP); Tohru MOGAMI, Tokyo (JP); Takahiro NAKAMURA, Tokyo (JP); Tsuyoshi HORIKAWA, Tokyo (JP)

(73) Assignees: NEC CORPORATION, Tokyo (JP); PHOTONICS ELECTRONICS TECHNOLOGY RESEARCH ASSOCIAT ION, Tokyo (JP)

(21) Appl. No.: 15/940,087

(22) Filed: Mar. 29, 2018

(30) Foreign Application Priority Data
Mar. 31, 2017 (JP) 2017-071594

(51) Int. Cl. G02F 1/225

(52) U.S. Cl. CPC G02F 1/2257; G02F 2001/212; G02F 2202/10; G02F 2202/105

(57) ABSTRACT

Provided is a silicon-based electro-optic modulator that exhibits an improved carrier plasma effect which is capable of realizing a low current density, low power consumption, a high modulation rate, low-voltage driving and high-speed modulation in a sub-micron region. The electro-optic modulator includes a waveguide structure including an Si or SiGe crystal. The electric field direction of light that propagates inside the waveguide structure is set to be approximately parallel with the <110> direction of the Si or SiGe crystal.

### INCORPORATION BY REFERENCE

This application is based upon and claims the benefit of priority from Japanese patent application No. 2017-071594, filed on Mar. 31, 2017, the disclosure of which is incorporated herein in its entirety by reference.

### TECHNICAL FIELD

The present invention relates to a silicon-based electro-optic modulator for high speed conversion of high speed electrical signals into optical signals that is required in the information processing and telecommunications fields.

### BACKGROUND ART

Silicon-based optical communication devices functioning at 1310 and 1550 nm fiber-optic communication wavelengths for a variety of systems such as for fiber-to-the-home and local area networks (LANs) are highly promising technologies which enable integration of optical functioning elements and electronic circuits together on a silicon platform by means of CMOS technologies.

In recent years, silicon-based passive optical devices such as waveguides, couplers and wavelength filters have been studied very extensively. Important technologies for manipulating optical signals for such communication systems include silicon-based active devices such as electro-optic modulators and optical switches, which also have been attracting much attention. However, optical switches and optical modulators that use a thermo-optic effect of silicon to change the refractive index operate at low speed, and accordingly their use is limited to cases of device speeds corresponding to modulation frequencies not higher than 1 Mb/second. Accordingly, in order to realize a high modulation frequency demanded in a larger number of optical communication systems, electro-optic modulators using an electro-optic effect are required.

Most of the electro-optic modulators proposed to date are devices which use a carrier plasma effect to change the free carrier density in a silicon layer and thereby change the real and imaginary parts of the refractive index, thus changing the phase and intensity of light. Such wide use of the above-mentioned carrier plasma effect is because of the fact that pure silicon does not exhibit a linear electro-optic effect (the Pockels effect) and that a change in its refractive index due to the Franz-Keldysh effect or the Kerr effect is very small. In modulators using free carrier absorption, the output light is directly modulated through a change in the absorption rate of light propagating in Si. As a structure using such changes in the phase or intensity of light, one employing a Mach-Zehnder interferometer is generally used, where intensity modulated optical signals can be obtained by causing optical phase differences in the two arms that include a phase modulating portion to interfere with each other.

Free carrier density in the electro-optical modulators can be varied by injection, accumulation, depletion or inversion of free carriers. Most of such devices that have been studied to date have low optical modulation efficiency, and accordingly, for optical phase modulation, require a length on the order of millimeters and an injection current density higher than 1 kA/cm³. In order to realize size reduction, higher integration and also a reduction in power consumption, a device structure giving high optical modulation efficiency is required, and if it is achieved, a reduction in the optical phase modulation length becomes possible. If the device size is large, the device becomes susceptible to the influence of temperature distribution over the silicon platform, and it is therefore assumed that a change in the refractive index of the silicon layer caused by a thermo-optic effect due to the temperature distribution cancels out the essentially existing electro-optic effect, thus raising a problem.

FIG. 1 shows a typical example of a silicon-based electro-optic phase modulator that uses a rib waveguide structure formed on an SOI substrate, shown in William M. J. Green, Michael J. Rooks, Lidija Sekaric, and Yurii A. Vlasov, Opt. Express 15, 17106-171113 (2007), “Ultra-compact, low RF power and 10 Gb/s silicon Mach-Zehnder modulator”. The electro-optic phase modulator is formed by slab regions that extend in the lateral direction with respect to the page surface on both sides of a rib-shaped core region including an intrinsic semiconductor region, with the slab regions being formed by a p-type and an n-type doping process, respectively. The aforementioned rib waveguide structure is formed utilizing the Si layer on a silicon-on-insulator (SOI) substrate. The structure shown in FIG. 1 corresponds to a PIN diode type modulator, and has a structure where the free carrier density in the intrinsic semiconductor region is changed by applying forward and reverse biases, and the refractive index is accordingly changed using a carrier plasma effect. In this example, semiconductor layer 4 of a first conductivity-type (p-type) that is the slab region on the left side of the drawing relative to rib-shaped core region (hereunder, referred to as “rib”) 1 including an intrinsic semiconductor silicon layer is formed to include first contact region 6 that was subjected to a doping process with a high concentration of a p-type impurity in a region that contacts first electrode 9. Semiconductor layer 5 of a second conductivity-type (n-type) that is the slab region on the right side of the drawing relative to rib 1 includes second contact region 7 that was subjected to a doping process with a high concentration of an n-type impurity in a region that contacts second electrode 10. A contact layer such as a silicide layer (not illustrated) may be formed at the interface between first electrode 9 and first contact region 6, and at the interface between second electrode 10 and second contact region 7.

In terms of the optical modulation operation, the optical modulator is connected to a power supply through the first and second electrodes so as to apply a forward bias to the PIN diode and thereby inject free carriers into the waveguide. When the forward bias is applied, the refractive index inside rib 1 that is the core region is changed as a result of the increase in free carriers, and phase modulation of light transmitted through the waveguide is thereby performed. However, the speed of the optical modulation operation is limited by the lifetime of free carriers in rib 1 and carrier diffusion in rib 1 when the forward bias is removed. Such a PIN diode phase modulator generally can support only an operation speed in the range of 10-50 Mb/second during the forward bias operation.

In this respect, it is possible to increase the switching speed by introducing impurities into the core to form a PN junction between p-type semiconductor layer 4 and n-type semiconductor layer 5 as illustrated in FIG. 2, and thereby shorten the carrier lifetime. However, there is the problem that the introduced impurities lower the optical modulation efficiency. The factor that has the greatest influence on the operation speed is a factor caused by the RC time constant, where the capacitance (C) at a time of forward bias application becomes very large as a result of a reduction in the carrier depletion layer width of the PN junction. While, theoretically, high speed operation of the PN junction could be achieved by applying a reverse bias, it requires a relatively high drive voltage or a large device size.

In WO2004/088394 A1, a silicon-based electro-optic modulator is proposed that comprises a body region of a second conductivity-type and a gate region of a first conductivity-type that is stacked so as to partly overlap with the body region, and a relatively thin dielectric layer is formed at the stacking interface. FIG. 3 illustrates a silicon-based electro-optic modulator comprising an SIS-type (silicon-insulator-silicon-type) structure according to this patent literature. This silicon-based electro-optic modulator is formed on an SOI platform, with the body region being formed by a relatively thin silicon surface layer of the SOI substrate, and the gate region being formed of a relatively thin silicon layer stacked on the SOI structure. The inside of the gate and body regions are each subjected to a doping processes, where the resultant doped portions are defined such that the carrier density change is controlled there by an external signal voltage. At such time, ideally, it is desirable to make an optical signal electric field coincide with the region where the carrier density is externally and dynamically controlled, in which situation optical phase modulation can be performed by accumulating, depleting or inverting free carriers on each side of the dielectric layer. However, in practice there is a problem in that the region where the carrier density dynamically changes is an extremely thin region with a size of about several tens of nanometers, which results in the problem that an optical modulation length on the order of millimeters is required, and the electro-optic modulator accordingly becomes large in size, and consequently high speed operation is difficult.

Therefore, in a silicon-based electro-optic modulator capable of being integrated on a Si substrate, using the technologies of the background art it has been difficult to realize an electro-optic modulator structure based on a carrier plasma effect which can realize, in a sub-micron region, a low current density, low power consumption, a high modulation rate, low-voltage driving and high-speed modulation. Although a structure has been proposed that improves overlapping between an optical field and a carrier modulation region in order to improve optical modulation efficiency, achieving a small-sized structure that drives with a lower voltage capable of CMOS drive is a difficult task. On the other hand, in regard to a silicon-based electro-optic modulator which can be downsized and designed to drive with a lower voltage, although a structure that uses a ring resonator has been proposed, there is a problem with regard to manufacturing accuracy as well as operational stability due to environmental temperature changes, and hence the realization of an Si-based electro-optic modulator that achieves high-performance has remained a problem.

### SUMMARY

An objective of the present invention is to provide a silicon-based electro-optic modulator that can realize a low current density, low power consumption, a high modulation rate, low-voltage driving, and high-speed modulation within a sub-micron area, and that exhibits an improved carrier plasma effect.

The hole mobility in the <110> direction of Si or SiGe is large in comparison to the mobility in the <100> direction. That is, because the carrier plasma effect is in inverse proportion to the effective mass of free carriers, in an electro-optic modulator including Si or SiGe that exhibits one conductivity-type, improvement of the carrier plasma effect is possible by manufacturing so that the electric field direction of light is approximately parallel to the <110> direction of Si or SiGe.

That is, according to one aspect of the present invention, an electro-optic modulator includes a waveguide structure including an Si or SiGe crystal, wherein an electric field direction of light that propagates inside the waveguide structure is set to be approximately parallel with a <110> direction of the Si or SiGe crystal.

According to one aspect of the present invention, it is possible to realize a high-performance electro-optic modulator that is silicon based.

### BRIEF DESCRIPTION OF THE DRAWINGS

FIG. 1 is a cross-sectional view of an electro-optic modulator including a PIN structure according to the related art;

FIG. 2 is a cross-sectional view of an electro-optic modulator including a PN structure according to the related art;

FIG. 3 is a cross-sectional view of an electro-optic modulator including an SIS structure according to the related art;

FIG. 4 is a cross-sectional view of an example of a structure of an electro-optic modulator including an SIS structure according to one example embodiment;

FIG. 5 is a cross-sectional view of an example of a structure of an electro-optic modulator including a PN junction according to one example embodiment;

FIG. 6 is a cross-sectional view of an example of a structure of an electro-optic modulator including a PIN junction according to one example embodiment;

FIG. 7 is a cross-sectional view of a modification example of an electro-optic modulator including an SIS structure according to one example embodiment;

FIG. 8 is a cross-sectional view of a modification example of an electro-optic modulator including a PN junction according to one example embodiment;

FIG. 9 is a cross-sectional view of another modification example of an electro-optic modulator including a PN junction according to one example embodiment;

FIGS. 10A-10I are cross-sectional views of manufacturing processes of an electro-optic modulator including an SIS structure according to one example embodiment;

FIG. 11 is a plan view illustrating an example embodiment of a Mach-Zehnder interferometer-type optical intensity modulation device that uses an electro-optic modulator of the present invention;

FIG. 12 is a plan view illustrating an example embodiment where Mach-Zehnder interferometer-type optical intensity modulation devices that each use an electro-optic modulator of the present invention are arranged in parallel; and

FIG. 13 is a plan view illustrating an example embodiment where Mach-Zehnder interferometer-type optical intensity modulation devices that each use an electro-optic modulator of the present invention are arranged in series.

### EXAMPLE EMBODIMENT

The electro-optic modulator according to the present invention includes an electro-optic modulator equipped with a waveguide structure including an Si or SiGe crystal. An electric field direction of light that propagates inside the waveguide structure is set to be approximately parallel to the <110> direction of the Si or SiGe crystal.

The electric field direction of light that propagates inside the waveguide structure is a direction that is orthogonal to the travelling direction of the light propagating inside the waveguide structure. Therefore, by designing the extending direction of the waveguide structure so as to be a direction that is orthogonal to the <110> direction of the Si or SiGe crystal, the electric field direction of light can be set to be parallel to the <110> direction of the Si or SiGe crystal.

In this case, because the hole mobility in the <110> direction in the Si or SiGe is greater than in the <100> direction and the effective mass of the hole is also smaller, a high-performance electro-optic modulator is realized in which the free carrier plasma effect is augmented and which has a small size and low power consumption. Note that, if the electric field direction of light is a direction within a range of ±40 degrees centering on the <110> direction, an effect of improving the hole mobility by around 10% is obtained. Therefore, in the present invention, the electric field direction of light is set to be a direction within a range of ±40 degrees centering on the <110> direction of the Si or SiGe crystal. The greatest hole mobility improvement effect is obtained by setting the electric field direction of light in a direction that is parallel to the <110> direction. In the present specification, a direction within a range of ±40 degrees centering on the <110> direction is referred to as a “direction that is approximately parallel to the <110> direction”.

Before describing specific example structures of the electro-optic modulator of the present invention, outline of a modulation mechanism in silicon will be described, as an operating principle of the present invention. Several of example embodiments illustrated in the drawings are related with a modulation structure, and the electro-optic modulator of the present invention is a modulator that utilizes an electro-optic effect (free carrier plasma effect) described below.

As described above, because a pure electro-optic effect is not present or is very weak in silicon, only a free carrier plasma effect or a thermo-optic effect can be used for optical modulation operation. For high-speed operation (Gb/second or greater) that is aimed at in the present invention, only the free carrier plasma effect is effective, and the effect is described by the following relations in first order approximation.

$$\begin{matrix}Δ n = - \frac{{e}^{2} {λ}^{2}}{8 {π}^{3} {c}^{3} {ɛ}_{0} n} ( \frac{Δ {N}_{e}}{{m}_{e}} + \frac{Δ {N}_{h}}{{m}_{h}} ) & ( 1 ) \\ Δ k = - \frac{{e}^{3} {λ}^{2}}{8 {π}^{3} {c}^{3} {ɛ}_{0} n} ( \frac{Δ {N}_{e}}{{m}_{e}^{2} {μ}_{e}} + \frac{Δ {N}_{h}}{{m}_{h}^{2} {μ}_{h}} ) & ( 2 )\end{matrix}$$

In the above expressions, Δn and Δk represent, respectively, the real and imaginary parts of a change in refractive index of a silicon layer, e represents the electron charge, λ represents the optical wavelength, ε₀ represents the permittivity of free space, n represents the refractive index of intrinsic semiconductor silicon, mₑ represents the effective mass of electron carriers, mₕ represents the effective mass of hole carriers, μₑ represents the mobility of electron carriers, μₕ represents the mobility of hole carriers, ΔNₑ represents a change in electron carrier concentration, and ΔNₕ represents a change in hole carrier concentration. That is, it is considered that decreasing the effective mass of hole carriers that are free carriers is an effective means for improving the free carrier plasma effect.

Experimental evaluations of the electro-optic effect in silicon have been performed, where it has been found that changes in the refractive index as a function of the carrier density at the 1310 and 1550 nm wavelengths used in optical communication systems agree well with the Drude expression. In an electro-optic modulator using the effect, the phase change amount Δθ is defined by the following expression (3).

$$Δθ = \frac{2 π}{λ} Δ {n}_{eff} L \qquad ( 3 )$$

In expression (3), L represents the length of the active layer in the direction of light propagation in the electro-optic modulator. Δn_{eff} represents the amount of change in the effective refractive index.

In the present invention, the above-described phase change amount is a larger effect compared to optical absorption, which enables an electro-optic modulator described below to exhibit a feature essentially as a phase modulator.

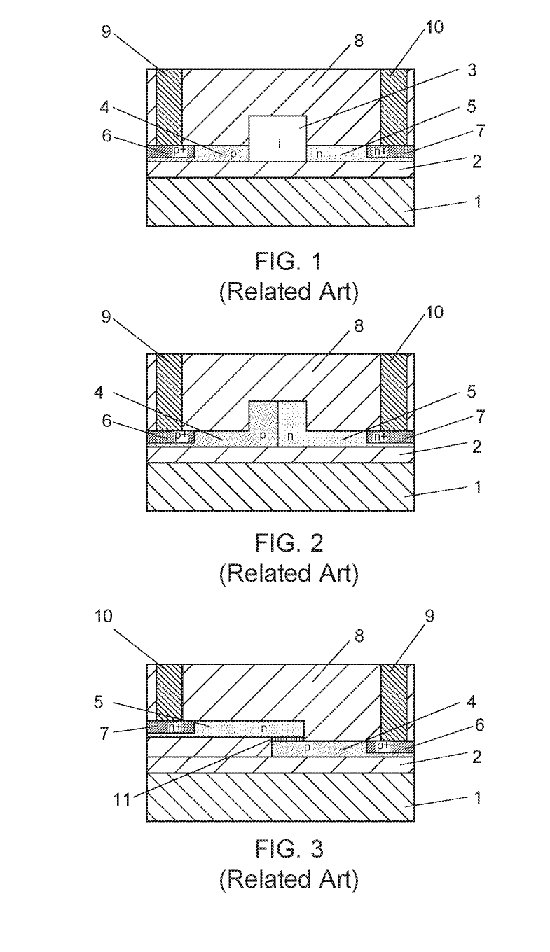

The PIN junction structure illustrated in FIG. 1, the PN junction structure illustrated in FIG. 2 and the SIS junction structure illustrated in FIG. 3 that are technologies of the background art each have a drawback in that overlap between an optical field and an area where the carrier density is modulated is small and the electro-optic modulator accordingly becomes large in size. This is because the common SOI substrate is oriented in the <100> direction, and when electro-optic modulators having the structures illustrated in the aforementioned drawings are manufactured using the common SOI substrate it is usual to manufacture the electro-optic modulators so that the electric field direction of light that propagates inside the electro-optic modulator coincides with the <100> direction of Si. In a case where the electric field direction of light coincides with the <100> direction, the free carrier plasma effect does not become large, and consequently the size of the electro-optic modulator must be made large.

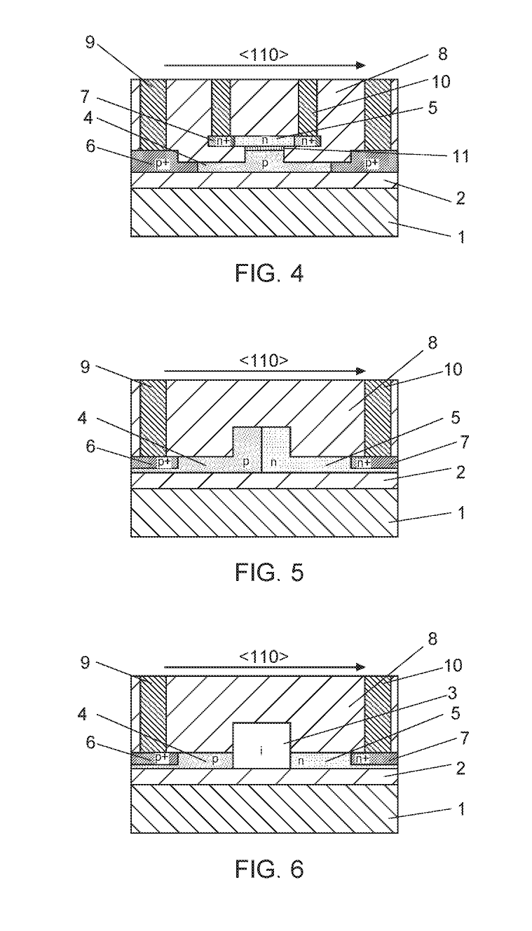

In a structure according to one example embodiment shown in FIG. 4, because the carrier plasma effect is in inverse proportion to the effective mass of free carriers, an electro-optic modulator including Si or SiGe doped to one conductivity-type is manufactured so that the electric field direction of propagating light becomes approximately parallel to the <110> direction of the Si or SiGe crystal. Although in the following description the first conductivity-type is mainly described as p-type and the second conductivity-type is mainly described as n-type, the conductivities may be the opposite to those described hereunder.

In the structure of the present invention shown in FIG. 4, semiconductor layer 4 doped to exhibit a first conductivity-type (p-type) is stacked via buried oxide layer 2 on support substrate 1 of an SOI substrate, and semiconductor layer 5 doped to exhibit a second conductivity-type (n-type) is at least partly stacked on semiconductor layer 4. Between the stacked semiconductor layers 4 and 5, dielectric layer 11 that is relatively thin is formed at the interface to form an SIS (semiconductor-insulator-semiconductor) junction. In this SIS junction, when electrical signals are supplied from first electrode 9 connected with first contact region 6 and second electrode 10 connected with second contact region 7, the free carriers are accumulated, depleted or inverted on each side of dielectric layer 11. The electro-optic modulator utilizes the fact that the refractive index felt by an optical signal electric field is modulated by the behaviors of free carriers. Semiconductor layer 4 that exhibits the first conductivity-type is a single crystal semiconductor layer of silicon (Si) or silicon-germanium (SiGe), and is manufactured using a substrate oriented in the <110> direction as the SOI substrate. Semiconductor layer 5 that exhibits the second conductivity-type can be formed by bonding together a polycrystalline silicon layer formed by a CVD method or the like and an InP- or InGaAs-based compound semiconductor layer. The structure is manufactured so that the electric field direction of light propagating through semiconductor layer 4 that exhibits the first conductivity-type becomes approximately parallel with the <110> direction of the Si or SiGe crystal constituting semiconductor layer 4. Because the hole mobility in the <110> direction is greater than in the <100> direction and the effective mass of the hole is also smaller, the free carrier plasma effect is enhanced and thereby a high-performance electro-optic modulator with small size and low power consumption is realized.

In addition, in order to reduce a loss in optical absorption caused by overlapping between the area in which the doping density is raised and the optical field, in this example embodiment, a waveguide shape having a rib/ridge shape as shown in the drawing is adopted, and the doping density of the slab region is increased. By employing such a structure, high-speed electro-optic device having small optical loss and a small RC time constant can be realized.

A maximum depletion layer thickness W is given by the following expression (4) in the thermal equilibrium state.

$$W = 2 \sqrt{\frac{{ϵ}_{s} kT ln ( \frac{{N}_{c}}{{n}_{i}} )}{{e}^{2} {N}_{c}}} \qquad ( 4 )$$

In expression (4), εₛ is the permittivity of the semiconductor layer, k the Boltzman constant, N_{c} the carrier density, nᵢ the intrinsic carrier concentration, and e is the electron charge. For example, the maximum depletion layer thickness is about 0.1 μm when N_{c} is 10¹⁷/cm³, and with an increase in the carrier density, the depletion layer thickness, that is, the thickness of a region in which carrier density modulation occurs is decreased.

The electro-optic modulator according to the present invention is not limited to the structure illustrated in FIG. 4, and the structures described in each of the example embodiments hereunder are also effective for use with the electro-optic modulator according to the present invention.

In a structure according to one example embodiment illustrated in FIG. 5, a rib waveguide structure includes a PN junction. The present invention can be similarly applied to a waveguide structure including a PIN junction instead of the PN junction, as illustrated in FIG. 6.

Further, in the present invention, distortion stress (tensile strain or compressive strain) can be applied in the <110> direction to the Si or SiGe layer. As a result, the effective mass of free carriers decreases further, and the modulation efficiency is improved.

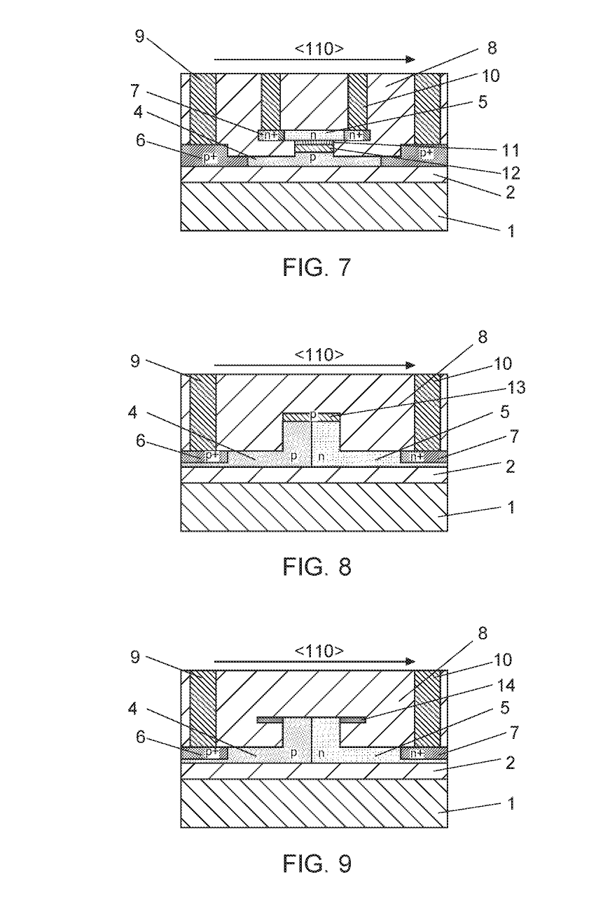

In a structure according to another example embodiment that is illustrated in FIG. 7, in addition to the configuration in FIG. 4, among the two semiconductor layers forming the SIS junction, Si₁₋ₓGeₓ (0<x≤0.9) layer (hereunder, referred to as “SiGe layer”) 12 of the same conductivity type (p-type) as semiconductor layer (p-type Si layer) 4 of the first conductivity-type is provided thereon, and application of distortion stress is performed by a stacking process on semiconductor layer 4 of the first conductivity type. Further, as illustrated in FIG. 8, p-type SiGe layer 13 is formed to apply distortion stress to at least one part of a PN junction waveguide structure. In addition, in FIG. 9 an example is illustrated of an electro-optic modulator in which SiNx film 14 is formed so that compressive strain is applied to at least one part of a PN junction waveguide structure. Application of distortion stress to a PIN junction waveguide is also effective.

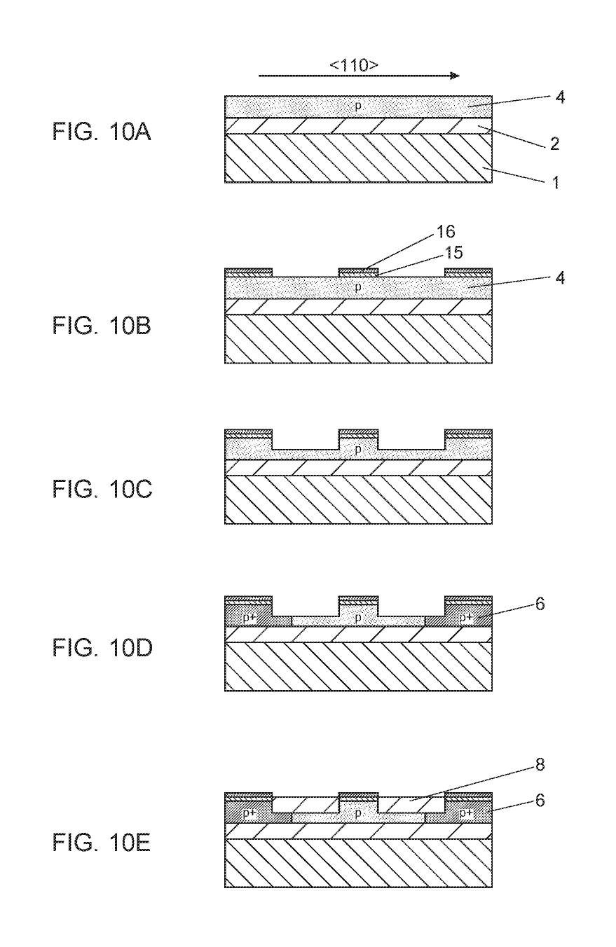

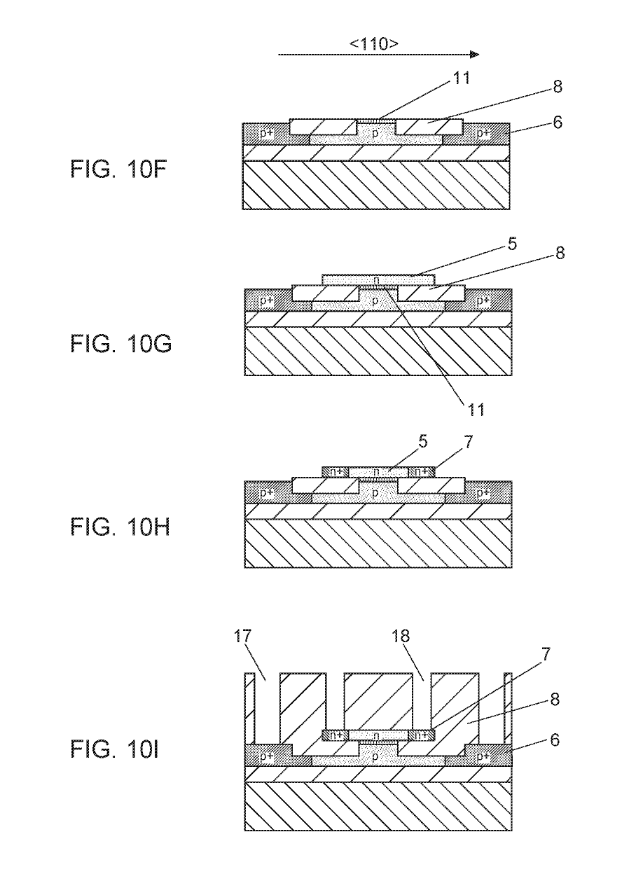

Next, a method for manufacturing the electro-optic modulator of one example embodiment will be described. FIGS. 10A-10I are multiple view drawings that include cross-sectional views of an example of a method for forming a waveguide structure including the SIS junction shown in FIG. 4.

FIG. 10A shows a cross-sectional view illustrating processes with respect to an SOI substrate used for forming the electro-optic modulator of the present invention. The SOI substrate includes a structure in which semiconductor layer (Si layer) 4 having a thickness of around 100 to 1000 nm is stacked on buried oxide layer 2 and support substrate 1, and in the present case a structure having buried oxide layer 2 with a thickness of 1000 nm or greater is adopted for reducing optical loss. Buried oxide layer 2 functions as a lower cladding layer of the waveguide structure. The SOI substrate having this structure can be formed by bonding Si layer 4 oriented in the <110> direction onto buried oxide layer 2 by a wafer bonding method. Si layer 4 on buried oxide layer 2 can be formed using a substrate doped in advance to exhibit the first conductivity-type, or it can be doped with phosphorus (P: n-type) or boron (B: p-type) in its surface layer by ion implantation or the like and subsequently annealed. In this case, an example is illustrated in which p-type is taken as the first conductivity-type and n-type is taken as the second conductivity-type. Further, in Si layer 4 on buried oxide layer 2, the <110> crystal orientation is disposed in the lateral direction with respect to the drawing. In the following processes, processes are performed so that the electric field direction of light propagating through the rib waveguide becomes approximately parallel thereto.

Next, as shown in FIG. 10B, a stack structure including a silicon oxide film and a SiNₓ layer is formed as a mask for forming the rib waveguide shape, and then patterning of oxide film mask 15 and hard mask 16 is performed by UV lithography and a dry etching method. At this time, oxide film mask 15 and hard mask 16 are also similarly formed on semiconductor regions that serve as contact regions. These masks are formed to extend in the depth direction with respect to the drawing (direction orthogonal to the <110> crystal orientation).

Next, as shown in FIG. 10C, patterning of Si layer 4 is performed taking oxide film mask 15 and hard mask 16 as masks, to form a rib waveguide structure that extends in the depth direction with respect to the drawing.

Next, as shown in FIG. 10D, the regions neighboring to and having an equal height to the height of the rib waveguide structure are heavily doped with an impurity, for example, boron (B), of the first conductivity type by an ion implantation method or the like to thereby form first contact regions 6.

Thereafter, as shown in FIG. 10E, oxide cladding layer 8 is stacked, and then flattening is performed by a CMP (chemical mechanical polishing) method. Oxide silicon can be used as oxide cladding layer 8. At this time, hard mask 16 functions as an etching stopper.

Next, as shown in FIG. 10F, the remaining hard mask 16 and oxide film mask 15 are removed by hot phosphoric acid and diluted fluoric acid processes or the like, and subsequently a relatively thin dielectric layer 11 of about 5 to 10 nm thickness is formed on a top layer portion of the rib waveguide structure. Hafnium oxide, alumina, silicon nitride, silicon oxide and a material composed of a combination of two or more of these materials or the like can be used as the dielectric.

Next, as shown in FIG. 10G, semiconductor layer 5 that exhibits the second conductivity-type is stacked, is patterned to have a width sufficient to enable formation of the second contact region, by a dry etching method or the like. For example, n-doped polycrystalline silicon can be used as semiconductor layer 5.

Thereafter, as shown in FIG. 10H, portions of semiconductor layer 5 exhibiting the second conductivity-type are heavily doped by an ion implantation method or the like with an impurity that exhibits the second conductivity-type, for example, phosphorus (P), to form second contact regions 7.

Next, as shown in FIG. 10I, an about 1 μm thick additional portion of the oxide cladding layer 8 is stacked, and first contact holes 17 and second contact holes 18 for obtaining connections to the first and second contact regions are formed by a dry etching method or the like.

Finally, by forming a metal layer of Ti/TiN/Al (Cu) or Ti/TiN/W within the first and second contact holes by a sputtering method or a CVD method and then patterning it by a reactive etching, first electrode 9 and second electrode 10 are formed, and the electro-optic modulator having the structure shown in FIG. 4 is then completed by making a connection between the first and second contact regions and a driving circuit (not shown).

The electro-optic modulator formed as described above can be used as a phase modulating portion of an electro-optic modulator device including a Mach-Zehnder interferometer. Hereunder, an electro-optic modulator device that uses the electro-optic modulator illustrated in FIG. 4 will be described. In this case, two of the waveguide structures shown in FIG. 4 are formed in parallel on an SOI substrate to constitute first and second arms.

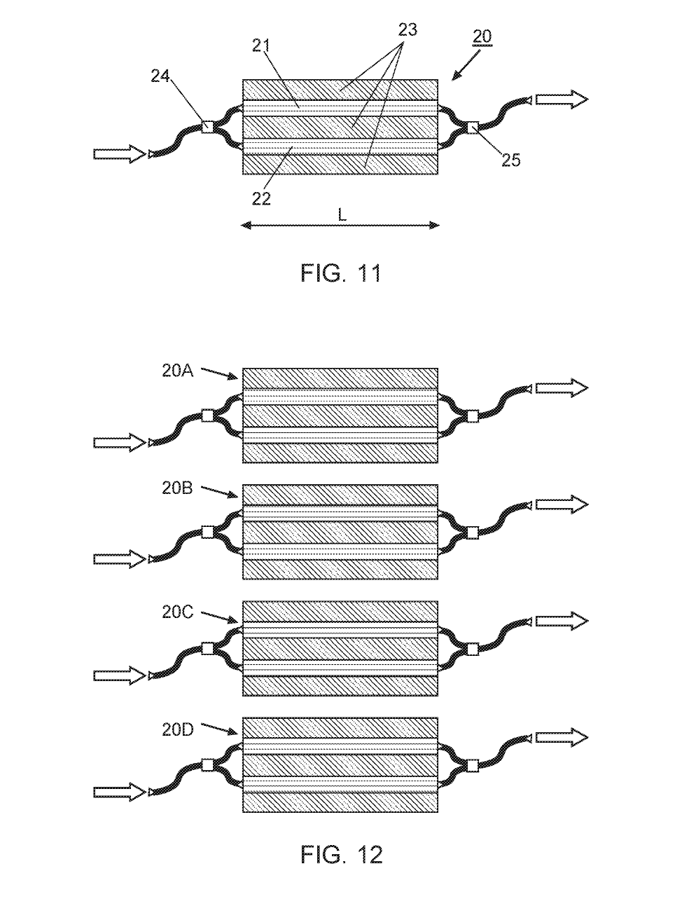

In an example embodiment shown in FIG. 11, by means of light splitting structure (light splitting unit) 24 arranged on the input side, input light is split into equal power signals entering, respectively, first arm 21 and second arm 22. Reference numeral 23 denotes an electrode pad for electro-optic device driving. Further, light combining structure (light combining unit) 25 is arranged on the output side.

Phase modulation of the respective optical signals are performed in first and second arms 21 and 22, and subsequently, phase interference between the optical signals is performed by light combining structure 25.

In this case, by applying a positive bias voltage to first arm 21, carrier accumulation is generated on each side of the dielectric layer of the SIS junction shown in FIG. 4, and by applying a negative bias voltage to second arm 22, carriers on each side of the dielectric layer of the SIS junction are removed. As a result, the refractive index felt by an optical signal electric field in electro-optic device 20 is decreased in a carrier accumulation mode, and is increased in a carrier removal (depletion) mode, and accordingly, the optical signal phase difference between first and second arms 21 and 22 is maximized. By combining the optical signals transmitted through, respectively, first and second arms 21 and 22 by means of light combining structure 25 on the output side, optical intensity modulation (an optical intensity modulated signal) is generated. The capability of the electro-optic device of the present invention to transmit optical signals of 40 Gbps or greater has been confirmed. The optical modulation length (active region length L of phase modulating portion) can be made, for example, 1 mm, and a reduction in size has been realized.

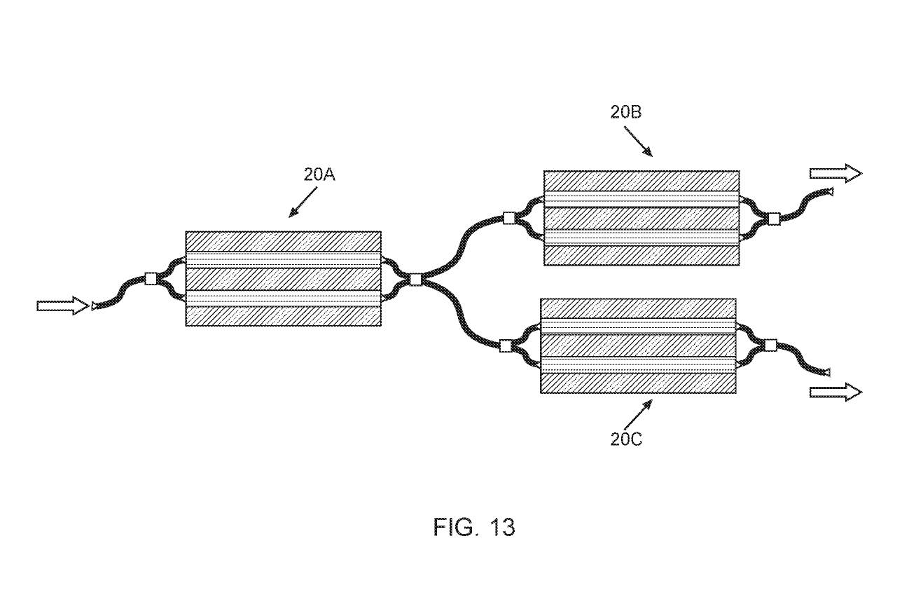

Further, the above-described electro-optic device 20 including a Mach-Zehnder interferometer can be applied also to a modulator device such as an electro-optic modulator and a matrix optical switch that has a higher transfer rate, by arranging a plurality of the electro-optic devices 20 in parallel or in series, as shown in FIGS. 12 and 13.

Although the present invention has been described above referring to example embodiments, the present invention is not limited to the above-described example embodiments. Various changes that can be understood by one skilled in the art can be made to the configuration and details of the present invention within the scope of the present invention.

What is claimed is:

1. An electro-optic modulator comprising a waveguide structure that includes an Si or SiGe crystal, wherein:
an electric field direction of light that propagates inside the waveguide structure is set to be approximately parallel with a <110> direction of the Si or SiGe crystal.

2. The electro-optic modulator according to claim 1, wherein:
the waveguide structure comprises an SIS (semiconductor-insulator-semiconductor) junction in which a dielectric layer is provided between two semiconductor layers that exhibit a different conductivity-type to each other, and one of the two semiconductor layers includes the Si or SiGe crystal.

3. The electro-optic modulator according to claim 2, wherein:
another of the two semiconductor layers includes a compound semiconductor layer.

4. The electro-optic modulator according to claim 2, wherein:
distortion stress is applied to the Si or SiGe crystal of the one of the two semiconductor layers at a face that contacts the dielectric layer.

5. The electro-optic modulator according to claim 3, wherein:
distortion stress is applied to the Si or SiGe crystal of the one of the two semiconductor layers at a face that contacts the dielectric layer.

6. The electro-optic modulator according to claim 1, wherein:
the waveguide structure comprises a PN junction or a PIN junction in the Si or SiGe crystal.

7. The electro-optic modulator according to claim 6, wherein:
distortion stress is applied to at least one part of the waveguide structure.

8. The electro-optic modulator according to claim 7, wherein:
a semiconductor layer that applies distortion stress is stacked on the PN junction or PIN junction.

9. The electro-optic modulator according to claim 7, wherein:
an insulating layer that applies a compressive strain in the <110> direction is formed on the PN junction or PIN junction.

10. An electro-optic modulator including a Mach-Zehnder interferometer, the Mach-Zehnder interferometer comprising:
a first arm which is the electro-optic modulator according to claim 1;
a second arm which is the electro-optic modulator according to claim 1 and arranged parallel to the first arm;
a light splitting unit which splits light at the input side; and
a light combining unit which combines light at the output side,
wherein optical intensity modulated signals are generated by performing phase modulation of optical signals in the first and second arms and by causing phase interference by means of the light combining unit.

11. A modulator device comprising:
a plurality of Mach-Zehnder interferometer type electro-optic modulators according to claim 10; and
arranging the plurality of Mach-Zehnder interferometer type electro-optic modulators in parallel.

12. A modulator device comprising:
a plurality of Mach-Zehnder interferometer type electro-optic modulators according to claim 10; and
arranging the plurality of Mach-Zehnder interferometer type electro-optic modulators in series.

13. An electro-optic modulator including a Mach-Zehnder interferometer, the Mach-Zehnder interferometer comprising:
a first arm which is the electro-optic modulator according to claim 2;
a second arm which is the electro-optic modulator according to claim 2 and arranged parallel to the first arm;
a light splitting unit which splits light at the input side; and
a light combining unit which combines light at the output side,
wherein optical intensity modulated signals are generated by performing phase modulation of optical signals in the first and second arms and by causing phase interference by means of the light combining unit.

14. A modulator device comprising:
a plurality of Mach-Zehnder interferometer type electro-optic modulators according to claim 13; and
arranging the plurality of Mach-Zehnder interferometer type electro-optic modulators in parallel.

15. A modulator device comprising:
a plurality of Mach-Zehnder interferometer type electro-optic modulators according to claim 13; and
arranging the plurality of Mach-Zehnder interferometer type electro-optic modulators in series.
